(19) United States
(12) Patent Application Publication
(10) Pub. No.: US 2022/0019797 A1
(43) Pub. Date: Jan. 20, 2022

(54) METHODS AND SYSTEMS FOR AGRICULTURAL BLOCK MAPPING

(71) Applicant: Agromentum Ltd., Yokne'am Illit (IL)

(72) Inventors: Iftach Birger, Yokne'am Illit (IL); Boaz Bachar, Fresno, CA (US); Tal Weksler, Yokne'am Illit (IL)

(21) Appl. No.: 17/489,118

(22) Filed: Sep. 29, 2021

Related U.S. Application Data
(63) Continuation of application No. PCT/US2020/025779, filed on Mar. 30, 2020.
(60) Provisional application No. 62/826,423, filed on Mar. 29, 2019.

(51) Int. Cl. G06K 9/00; G06K 9/32; G06K 9/46; G06T 7/00; G06T 5/20; G06T 5/00; G06Q 50/02

(52) U.S. Cl. CPC G06K 9/00657; G06K 9/3241; G06K 9/4609; G06T 2207/30188; G06T 5/20; G06T 5/002; G06Q 50/02; G06T 7/0012

(57) ABSTRACT

A method includes receiving input data regarding an agricultural block, wherein the input data includes a row span of the agricultural block, a tree span of the agricultural block, a block heading of the agricultural block, at least one image of the agricultural block, and at least one location sample obtained at a location in a row within the agricultural block; performing image recognition on the at least one image of the agricultural block to identify lines within the at least one image of the agricultural block; identifying at least one polygon within the agricultural block based on the lines within the at least one image of the agricultural block; and identifying map rows within each of the at least one polygon.

### CROSS-REFERENCE TO RELATED APPLICATION

This application is a Continuation of International (PCT) Patent Application No. PCT/US2020/025779 filed Mar. 30, 2020, which relates to and claims the benefit of commonly-owned, co-pending U.S. Provisional Patent Application No. 62/826,423, filed Mar. 29, 2019, entitled “METHODS AND SYSTEMS FOR AGRICULTURAL BLOCK MAPPING,” the contents of which are incorporated herein by reference in their entirety.

### FIELD OF INVENTION

The exemplary embodiments relate to methods and systems for generating maps of agricultural blocks within, for example, orchards or vineyards.

### BACKGROUND OF INVENTION

Typically, blocks of trees within orchards include groups of trees planted in straight rows. Within each block, the distance between adjacent rows (known as the “row gap” or “row span”) is constant and the distance between each tree within a row (known as the “tree span”) is constant. To analyze and evaluate the quality of operations within an orchard (for example, to detect errors in the behavior of a tractor that is spraying pesticides), it may be desirable to build a map of such blocks.

### SUMMARY OF THE INVENTION

In an embodiment, a method for generating an agricultural block map includes receiving input data regarding an agricultural block, the input data including a row span, a tree span, a block heading, at least one image of the block, and at least one location sample obtained at a location in a row within the block; performing image recognition on the at least one image to identify lines within the at least one image; identifying at least one polygon within the block based on the lines within the at least one image; and generating rows within each polygon based on the row heading, the row spacing, and the at least one location sample.

In an embodiment, a method for detecting lines within an image of an agricultural block includes performing thresholding on the block image; converting the block image to a grayscale image based on the thresholding; performing additional thresholding on the grayscale image; converting the grayscale image to a binary image based on the additional thresholding; smoothing the binary image to generate a smoothed binary image; detecting at least one line within the binary image; analyzing a vector of a parametric line equation of each of the at least one line; sorting the at least one line by Y-intercept; and filtering the at least one line by proximity.

In some embodiments, a method includes receiving input data regarding an agricultural block, wherein the input data includes a row span of the agricultural block, a tree span of the agricultural block, a block heading of the agricultural block, at least one image of the agricultural block, and at least one location sample obtained at a location in a row within the agricultural block; performing image recognition on the at least one image of the agricultural block to identify lines within the at least one image of the agricultural block; identifying at least one polygon within the agricultural block based on the lines within the at least one image of the agricultural block; and identifying map rows within each of the at least one polygon.

In some embodiments, the step of performing image recognition on the at least one image of the agricultural block to identify lines within the at least one image of the agricultural block includes sub-steps of performing thresholding on the at least one image; converting the at least one image to at least one grayscale image based on the thresholding; performing additional thresholding on the at least one grayscale image; converting the at least one grayscale image to at least one binary image based on the additional thresholding; smoothing the at least one binary image to generate at least one smoothed binary image; detecting at least one line within the at least one smoothed binary image; analyzing a vector of a parametric line equation of each of the at least one line; sorting the at least one line by Y-intercept; and filtering the at least one line by proximity.

In some embodiments, a threshold for the step of performing thresholding on the at least one image is calculated using Otsu's method. In some embodiments, the step of converting the at least one image to at least one grayscale image is performed using an averaging process, a desaturation process, or a decomposition process. In some embodiments, the step of performing additional thresholding on the at least one grayscale image is performed using clustering-based thresholding or Otsu's method. In some embodiments, the step of smoothing the at least one binary image to generate at least one smoothed binary image is performed using Gaussian blurring. In some embodiments, the step of detecting at least one line within the at least one smoothed binary image is performed using (a) a voting scheme, (b) a morphologic method including steps of dilation, erosion, and dilation, or (c) a Hough transform algorithm. In some embodiments, the step of filtering the at least one line by proximity is performed based on at least the row span.

In some embodiments, the step of identifying at least one polygon within the agricultural block based on the lines within the at least one image of the agricultural block is performed by a process that includes tracing a path around each of the at least one polygon.

In some embodiments, the step of identifying map rows within each of the at least one polygon is performed based on at least based on the row heading of the agricultural block, the row spacing of the agricultural block, and the at least one location sample obtained at the location in the row within the agricultural block.

In some embodiments, a method also includes generating a tree-level map of the agricultural block. In some embodiments, the step of generating the tree-level map of the agricultural block is performed by generating a tree-level map for each of the at least one polygon within the agricultural block. In some embodiments, the step of generating a tree-level map for each of the at least one polygon within the agricultural block includes: generating a plurality of lines of trees within each of the at least one polygon; generating a first tree location of each one of the plurality of lines at an intersection of the each one of the plurality of lines and a boundary of the polygon in which the each one of the plurality of lines is located; and generating subsequent tree locations along the each one of the plurality of lines based on the first tree location and the tree span. In some embodiments, the plurality of lines of trees is generated based on assuming that a line of trees exists between each pair of adjacent rows within each of the at least one polygon. In some embodiments, the plurality of lines of trees is further generated based on assuming that a line of trees exists between each boundary of the at least one polygon and a one of the rows that is adjacent to each boundary of the at least one polygon.

### BRIEF DESCRIPTION OF THE FIGURES

FIG. 1 shows a map of an agricultural block.

FIG. 2 shows a flowchart of an exemplary method for creating an agricultural block map.

FIG. 3 shows a flowchart of an exemplary method of image processing to detect lines that is utilized during the performance of the exemplary method of FIG. 2.

FIG. 4 shows an exemplary polygon generated based on lines detected by the exemplary method shown in FIG. 3.

FIG. 5 shows an exemplary block map generated based on the method of FIG. 3.

### DETAILED DESCRIPTION

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

Among those benefits and improvements that have been disclosed, other objects and advantages of this invention can become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the present invention is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention. Further, when a particular feature, structure, or characteristic is described in connection with an implementation, it is submitted that it is within the knowledge of one skilled in the art to affect such feature, structure, or characteristic in connection with other implementations whether or not explicitly described herein.

The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor.

In some embodiments, an agricultural block map may include roads within a block as well as trails that are located between rows of trees. Ideally, each block would include only rows of trees of even spacing; in such a situation, once a point (e.g., identified by latitude and longitude) has been located at the middle of one row, a point in an adjacent row can be located simply by “jumping” in the direction of the next row by the row gap, and the point at this location would be at the center of the next row. However, one technological problem in the agricultural field is that a typical actual orchard also would include trail(s) and/or road(s) having width(s) that is/are higher and/or lower than a particular row span, causing such “jumping” not to arrive at the correct location.

As discussed above, standard techniques for generating block maps by “jumping” row locations based solely on row span present an agri-technological challenge due to the deficiency of, for example, not properly accounting for the presence of roads and/or other landscape-related imperfections within blocks. As detailed below, the exemplary embodiments of the present disclosure provide various technological solutions to solve at least the above identified agri-technological problem such as performing analysis of an image of a block to identify the locations of internal roads before using row span to identify the locations of roads.

Therefore, in an exemplary embodiment, the present disclosure provides one technological solution based at least in part on a mapping process that involves construction of smaller polygons within a larger polygon defining a main block. In such embodiment, the smaller polygons are surrounded by the boundaries of the block and trails or rows within the block. Such an embodiment, as another technological solution, may also utilize image recognition to detect trees and trails, location samples taken from tractors that are driving along the trails so as to define locations that are trails rather than trees, and inputs such as row span, tree span, and row heading (e.g., rows may be oriented east-west, northeast-southwest, etc.).

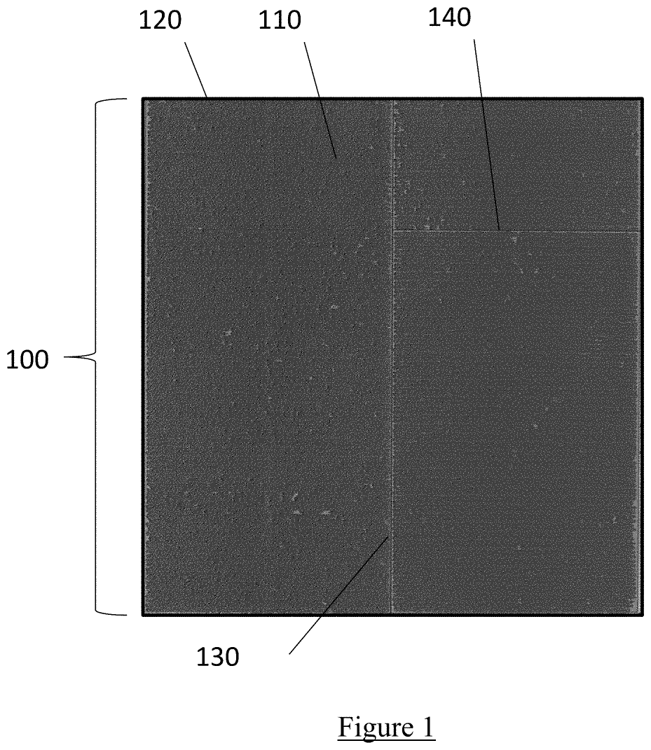

FIG. 1 shows a map 100 of a block 110 having a boundary 120. In some embodiments, a block is defined as a geographical area that a grower considers to be one block. In the block 110, rows are defined by trees planted west to east (i.e., left to right in the direction that the map 100 is oriented). The block 110 also includes a road 130 extending in a north-south direction through the center of the block and a service road 140 extending in an east-west direction from the road 130 to the boundary 120. In the block 110, trees have a row span of six meters. Consequently, as described above, if a point (e.g., a location sample from a tractor) is located at the center of a first row, points in adjacent rows may be located by “jumping” at intervals of six meters. However, due to the presence of the service road 140, such “jumping” will not arrive at an appropriate block map.

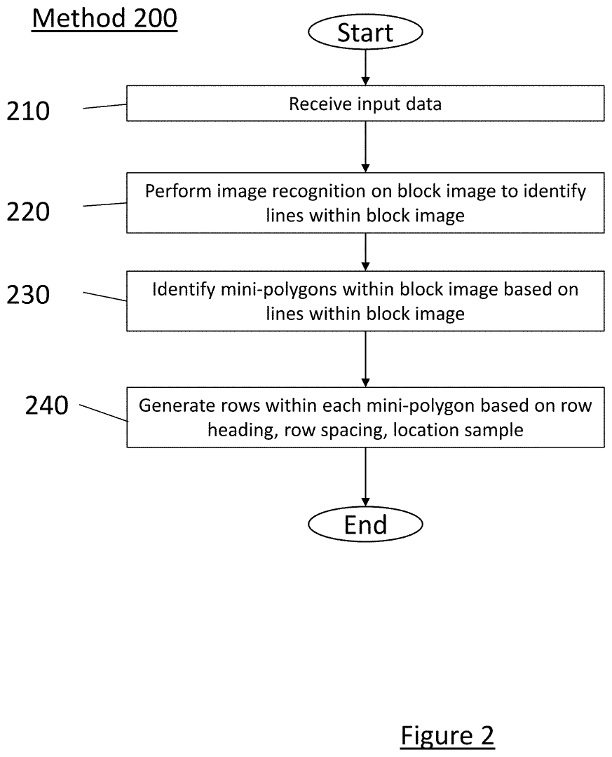

FIG. 2 shows a flowchart of a method 200 for the exemplary technological solution of creating a block map based on the information described above. In some embodiments, the method 200 is implemented by computer-executable code executed by appropriate computer hardware. In step 210, the computer receives input data. In some embodiments, the input data includes (a) row span, (b) tree span, (c) block heading, (d) at least one image of the block, and (e) at least one GPS sample obtained at a location in a row within the block. In some embodiments, the row span is a distance (which may be expressed in, for example, meters, feet, centimeters, or any other appropriate unit). In some embodiments, the tree span is a distance (which may be expressed in, for example, meters, feet, centimeters, or any other appropriate unit). In some embodiments, the block heading is a geographical orientation (e.g., a compass heading, etc.). In some embodiments, the image is a top view image of a block (e.g., the block 110 described above with reference to FIG. 1) encoded in any known image format (e.g., TIFF, JPEG, GIF, etc.). In some embodiments, the image is obtained from open-source satellite data, which is commonly available in the United States. In some embodiments, the image is a photograph obtained through the use of a drone. In some embodiments, the image is obtained through any other suitable means for obtaining a top view image of a block. In some embodiments, the GPS sample is obtained by a tractor having an GPS receiver located within the block. In some embodiments, the GPS sample is obtained using another suitable process. In some embodiments, the GPS sample has an accuracy of less than two meters.

Continuing to refer to FIG. 2, in step 220, as another technological solution, the exemplary method may further utilize an image recognition that is performed on the block image to identify trees and roads. In some embodiments, image recognition may apply a feature extraction algorithm. In some embodiments, the purpose of the feature extraction is to find imperfect instances of objects within a certain class of shapes by a voting procedure. In some embodiments, the feature extraction algorithm uses a Hough transform to find straight lines within an image. In some embodiments, as another technological solution, the image is binarized using thresholding and positive instances are catalogued in an example's data set.

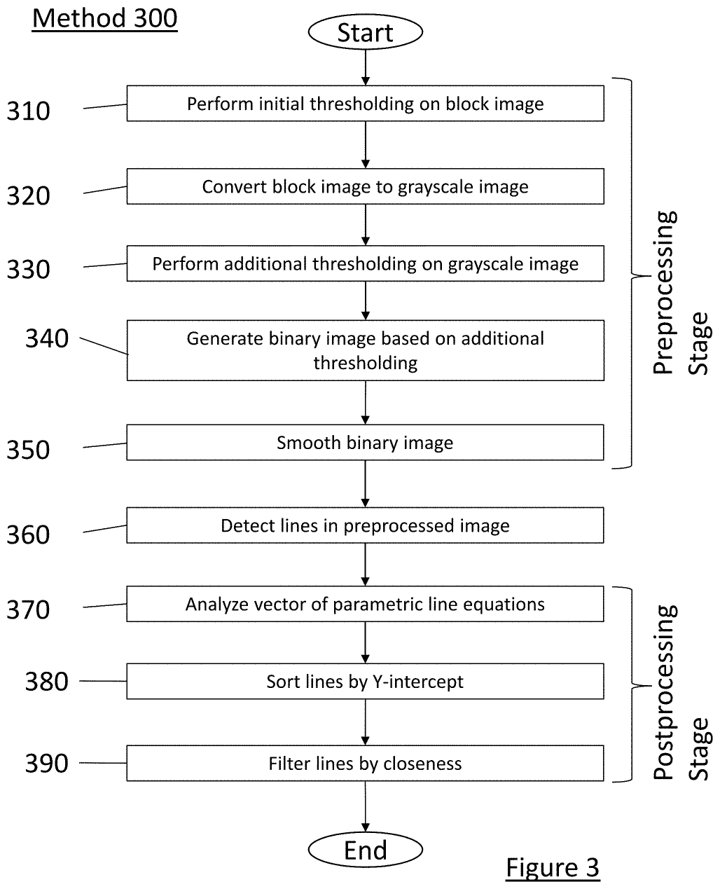

FIG. 3 shows a flowchart of an exemplary method 300 for image recognition the image recognition of step 220). As described above, image recognition may be performed on an image such as a satellite image of a block. In some embodiments, if necessary, the image may be converted to a suitable image format before performance of the method 300. Referring to the method 300 generally, steps 310 through 350 may be termed a “preprocessing stage” and steps 370 through 390 may be termed a “postprocessing stage.”

Continuing to refer to FIG. 3, in step 310, thresholding is applied to an image. In some embodiments, the threshold value for the thresholding is calculated using Otsu's method. In step 320, the image is converted to a grayscale image using known techniques for converting color images to grayscale images (e.g., averaging, desaturation, decomposition, etc.).

Continuing to refer to FIG. 3, in step 330, additional thresholding is applied to the grayscale image produced by step 320. In some embodiments, the additional thresholding includes clustering-based thresholding. In some embodiments, the additional thresholding is performed using Otsu's method. In step 340, a binary image is generated based on the results of the additional thresholding of step 330. In step 350, the binary image is smoothed. In some embodiments, the smoothing is performed using Gaussian blurring. As noted above, following step 350, the “preprocessing” stage is complete and results in a preprocessed binary image.

Continuing to refer to FIG. 3, in step 360, lines corresponding to roads are detected in the preprocessed image. In some embodiments, detection is performed using a voting scheme. In some embodiments, only the boldest lines (which correspond to roads) are detected, while other lines (which may correspond to rows) are ignored. In some embodiments, this is accomplished using a morphologic method including steps of dilation, erosion, and dilation. In some embodiments, detection is performed using a Hough transform algorithm.

Following step 360, the “postprocessing” stage begins. In some embodiments, postprocessing may be performed in order to eliminate duplicate lines. For example, in some cases, the Hough transform algorithm may return several parallel lines, each such line spaced a couple of pixels away from the next, and all such lines may correspond to a single wide road; in such cases, postprocessing would eliminate such duplicates. In step 370, as another technological solution, the vectors of the parametric linear line equations are analyzed and grouped. In some embodiments, this step involves identifying the vector (e.g., orientation) of each detected line. In some embodiments, lines having the same heading are grouped with one another. In step 380, the calculated lines are sorted by Y-intercept by their intersection with a defined Y-axis). Accordingly, such lines will be ordered as the closest to the block boundary, the second closest to the block boundary, etc. In step 390, the lines are filtered by closeness to one another. In some embodiments, all lines from any given group (i.e., lines that have been grouped based on vector in step 370) are reviewed in order of Y-intercept (i.e., as determined in step 380) and all lines that any line that is less than a threshold distance from the prior line is removed so as to provide one line per road. In some embodiments, the threshold distance is the row span.

The result of the method 300 is data defining the positioning of lines within a block (for example, the positions of the road 130 and the service road 140 within the block 110 described above with reference to FIG. 1, It will be apparent to those of skill in the art that the method 300 may also be performed on an image of a block having no roads therein, in which case no lines will be output by the method 300. It will also be apparent to those of skill in the art that in some embodiments, certain steps of the method 300 are omitted. For example, if the source image is a grayscale image, steps 310 and 320 may be omitted.

As noted above, the method 300 may be the image recognition step 220 of method 200. Therefore, the output of the method 300 may be the output of step 220 of the method 200. Referring back to FIG. 2, in step 230, mini-polygons are detected within the large polygon defining the boundaries of a block. In some embodiments, mini-polygons are detected by calculating the intersection of each line output by step 220 with all other lines output by step 220 and within the boundaries of the larger polygon. Each group of intersections surrounding an area of the large block defines a mini-polygon. In one illustrative and non-limiting example, a block may include two roads R1 and R2, each of which has ends A and B, which may be referred to as R1A, R1B, R2A, and R2B. A path is traced by beginning at a vertex of the block polygon and tracing clockwise around the polygon. If the path reaches one of the road endpoints, the path being traced changes direction to follow the road (for example, along road R1 from point R1A toward point R1B, and then continuing in a clockwise direction in the same manner until a closed path has been formed, defining a mini-polygon. The process then continues around the block polygon by returning to the point at which the polygon was originally left (in the example above, at point RIA) and continuing likewise around the block polygon until the original starting point has been reached.

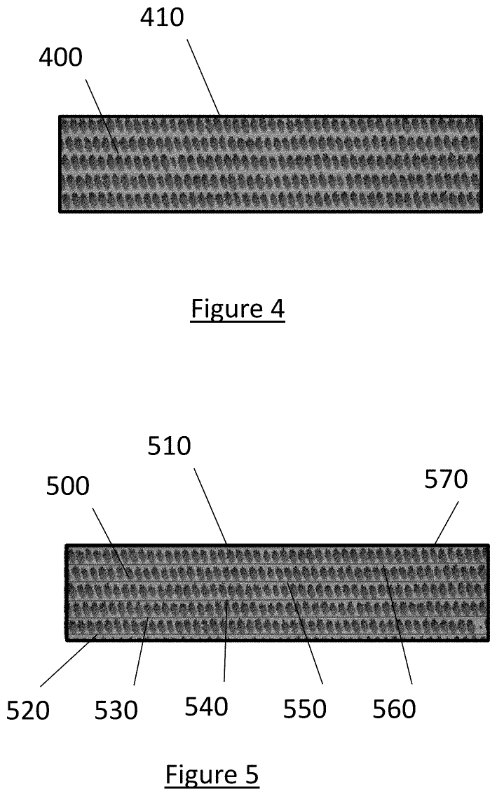

For example, referring to the block 100 shown in Figure A, the path would begin at the top left corner of block 100, trace clockwise to the top end of line 130, travel along line 130 to the bottom end of line 130, and continue clockwise to the bottom left coiner of block 100 and back to the top left corner of block 100. Next, the process would return to the top end of line 130 and trace clockwise to the top right corner of block 100, to the right end of line 140, to the left end of line 140, and back to the top end of line 130. Last, the process would return to the right end of line 140 and trace to the bottom right corner of block 100, to the bottom end of line 130, to the left end of line 140, and back to the right end of line 140, At this point, the entirety of the block 100 has been subdivided into sub-polygons. FIG. 4 shows an example of a mini-polygon 400 that may be generated by step 230. The mini-polygon 400 includes a boundary 410 that may be defined by a combination of the boundaries of a block polygon and lines detected in step 220.

Referring back to FIG. 2, the result of step 230 is a mini-polygon (e.g., the mini-polygon 400 shown in FIG. 4) that contains only trees and rows between trees, and does not include roads (other than at its boundaries). In step 240, geographical lines defining rows within the mini-polygon are generated. In addition to the boundaries of the mini-polygon, step 240 uses as input the row heading, the row span, and a latitude-longitude location sample of a point at a center of a row within the mini-polygon, all of which are inputs received in step 210, During step 240, the latitude-longitude location sample is used as a starting point. From the starting point, a starting line is drawn along the row heading in both directions until the boundaries of the mini-polygon are reached. Lines parallel to the starting line are then generated to either side of the starting line, spaced from the starting line by the row span, until the boundaries of the mini-polygon are reached. In some embodiments, step 240 is repeated for each of a plurality of mini-polygons generated by step 230.

In some embodiments, the method 200 also includes step 250, in which a tree-level map is generated. In step 250, lines of trees are generated based on the rows identified in step 240 and the tree span. In some embodiments, a line of trees is assumed to exist between each row identified in step 240 and the adjacent rows/mini-polygon boundary. In some embodiments, for each assumed line of trees, a first tree is located at one end of the line adjacent a boundary of the mini-polygon, and subsequent trees are located regularly at intervals equal to the tree span until the opposite end of the mini-polygon is reached.

Following step 240 (or step 250 in embodiments in which this step is included), the method 200 is complete. The result of the method 200 is block maps for one or more mini-blocks within a block. FIG. 5 shows a block map 500 generated based on the mini-polygon 400 shown in FIG. 4. The block map 500 includes a boundary 510 (e.g., as determined by step 230) and rows 520, 530, 540, 550, 560, and 570 (e.g., as determined by step 240).

In some embodiments, a block map generated by the method 200 (e.g., the block map 500 of FIG. 5) is suitable for use in various application relating to operations that may be performed in an orchard including the block shown in the block map. For example, the block map may be used as a point of comparison for GPS data samples describing the movement of a tractor that is applying pesticides within the block to detect spraying errors.

While one or more embodiments of the present disclosure have been described, it is understood that these embodiments are illustrative only, and not restrictive, and that many modifications may become apparent to those of ordinary skill in the art, including that various embodiments of the inventive methodologies, the inventive systems, and the inventive devices described herein can be utilized in any combination with each other. Further still, the various steps may be carried out in any desired order (and any desired steps may be added and/or any desired steps may be eliminated).

What is claimed is:

1. A method, comprising:
receiving input data regarding an agricultural block,
wherein the input data includes a row span of the agricultural block, a tree span of the agricultural block, a block heading of the agricultural block, at least one image of the agricultural block, and at least one location sample obtained at a location in a row within the agricultural block;
performing image recognition on the at least one image of the agricultural block to identify lines within the at least one image of the agricultural block;
identifying at least one polygon within the agricultural block based on the lines within the at least one image of the agricultural block; and
identifying map rows within each of the at least one polygon.

2. The method of claim 1, wherein the step of performing image recognition on the at least one image of the agricultural block to identify lines within the at least one image of the agricultural block comprises sub-steps of:
performing thresholding on the at least one image;
converting the at least one image to at least one grayscale image based on the thresholding;
performing additional thresholding on the at least one grayscale image;
converting the at least one grayscale image to at least one binary image based on the additional thresholding;
smoothing the at least one binary image to generate at least one smoothed binary image;
detecting at least one line within the at least one smoothed binary image;
analyzing a vector of a parametric line equation of each of the at least one line;
sorting the at least one line by Y-intercept; and
filtering the at least one line by proximity.

3. The method of claim 2, wherein a threshold for the step of performing thresholding on the at least one image is calculated using Otsu's method.

4. The method of claim 2, wherein the step of converting the at least one image to at least one grayscale image is performed using an averaging process, a desaturation process, or a decomposition process.

5. The method of claim 2, wherein the step of performing additional thresholding on the at least one grayscale image is performed using clustering-based thresholding or Otsu's method.

6. The method of claim 2, wherein the step of smoothing the at least one binary image to generate at least one smoothed binary image is performed using Gaussian blurring.

7. The method of claim 2, wherein the step of detecting at least one line within the at least one smoothed binary image is performed using (a) a voting scheme, (b) a morphologic method including steps of dilation, erosion, and dilation, or (c) a Hough transform algorithm.

8. The method of claim 2, wherein the step of filtering the at least one line by proximity is performed based on at least the row span.

9. The method of claim 1, wherein the step of identifying at least one polygon within the agricultural block based on the lines within the at least one image of the agricultural block is performed by a process that includes tracing a path around each of the at least one polygon.

10. The method of claim 1, wherein the step of identifying map rows within each of the at least one polygon is performed based on at least based on the row heading of the agricultural block, the row spacing of the agricultural block, and the at least one location sample obtained at the location in the row within the agricultural block.

11. The method of claim 1, further comprising the step of generating a tree-level map of the agricultural block.

12. The method of claim 11, wherein the step of generating the tree-level map of the agricultural block is performed by generating a tree-level map for each of the at least one polygon within the agricultural block.

13. The method of claim 12, wherein the step of generating a tree-level map for each of the at least one polygon within the agricultural block includes:
generating a plurality of lines of trees within each of the at least one polygon;
generating a first tree location of each one of the plurality of lines at an intersection of the each one of the plurality of lines and a boundary of the polygon in which the each one of the plurality of lines is located; and
generating subsequent tree locations along the each one of the plurality of lines based on the first tree location and the tree span.

14. The method of claim 13, wherein the plurality of lines of trees is generated based on assuming that a line of trees exists between each pair of adjacent rows within each of the at least one polygon.

15. The method of claim 14, wherein the plurality of lines of trees is further generated based on assuming that a line of trees exists between each boundary of the at least one polygon and a one of the rows that is adjacent to each boundary of the at least one polygon.
